(19) United States
(12) Patent Application Publication
(10) Pub. No.: US 2025/0294376 A1
(43) Pub. Date: Sep. 18, 2025

(54) SYSTEMS AND METHODS FOR FACILITATING DISTRIBUTED COMMUNICATIONS AND COMPUTING OVER WIRELESS COMMUNICATION NETWORKS

(71) Applicant: AT&T Intellectual Property I, L.P., Atlanta, GA (US)

(72) Inventor: Thomas Novlan, Jonestown, TX (US)

(73) Assignee: AT&T Intellectual Property I, L.P., Atlanta, GA (US)

(21) Appl. No.: 18/932,712

(22) Filed: Oct. 31, 2024

Related U.S. Application Data
(60) Provisional application No. 63/565,850, filed on Mar. 15, 2024.

(51) Int. Cl. H04W 24/02; H04W 12/06; H04W 76/34

(52) U.S. Cl. CPC H04W 24/02; H04W 12/06; H04W 76/34

(57) ABSTRACT

Aspects of the subject disclosure may include, for example, implementing a cloud network platform to run control plane functionalities and first user plane functionalities, implementing an edge network platform to run both communication functionalities and second user plane functionalities, and implementing a site network platform to run a radio layer 1 (L1) functionalities. Other embodiments are disclosed.

### CROSS-REFERENCE TO RELATED APPLICATION(S)

The present application claims the benefit of priority to U.S. Provisional Application No. 63/565,850 filed on Mar. 15, 2024, which is hereby incorporated herein by reference in its entirety.

### FIELD OF THE DISCLOSURE

The subject disclosure relates to systems and methods for facilitating distributed communications and computing services and applications over wireless communication networks.

### BACKGROUND

Both LTE and 5G support use cases for local area and distributed data (e.g., a Device-to-Device (D2D)/Sidelink/Vehicle-to-Everything (V2X)). D2D sidelink is a communication technology that enables direct data exchange between devices without using a cell tower. It is a part of 5G networks and used to support V2X communications. Both 4G and 5G air interfaces, however, may be largely designed for wide area and narrow band systems where a control overhead limits system capacity (e.g., n5 with Dynamic Spectrum Sharing (DSS)). DSS allows mobile operators to share the same frequency bands for different users, which can increase connectivity. In contrast, 802.11-like technologies have been more commercially successful for local area and massively wideband systems compared to 3GPP-based systems. There is a need to enhance an interface between a radio access network (RAN) and a core network for the distributed computing.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A depicts illustrative differences between a 5G/state of the art communication architecture and a 6G technology focus.

FIG. 2B depicts illustrative 5G and 6G environments.

FIG. 2C depicts exemplary protocol stack layers in traditional 5G environment.

FIG. 2D is a block diagram illustrating an example, non-limiting embodiment of a system architecture functioning within the communication network of FIG. 1 in accordance with various aspects described herein.

FIG. 2E is a block diagram illustrating an example, non-limiting embodiment of another system architecture functioning within the communication network of FIG. 1 in accordance with various aspects described herein.

FIG. 2F is a block diagram illustrating an example, non-limiting embodiment of further another system architecture functioning within the communication network of FIG. 1 in accordance with various aspects described herein.

FIG. 2G depicts an illustrative embodiment of a method in accordance with various aspects described herein.

FIG. 2H depicts an illustrative embodiment of another method in accordance with various aspects described herein.

FIG. 2I depicts an illustrative embodiment of further another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for systems and methods for facilitating distributed communications and computing services and applications over wireless communication networks including but not limited to 5G or 6G networks. More specifically, the subject disclosure describes an air interface protocol stack design and open radio access network (ORAN) architecture to optimize quality of experience (QoE) for communication and computation services. Other embodiments are described in the subject disclosure. The systems and methods facilitate and implement a network platform having dynamic ability to move resources required for computation from an edge of a wireless communication network to a base station to a user equipment and at the same time, ensures that a communication link can support the moving of the resources required for the computation to meet throughput and latency requirements of applications.

One or more aspects of the subject disclosure are directed to a system including a processing system including a processor and a memory that stores executable instructions that, when executed by the processing system, facilitate performance of operations. The operations include allocating, to an edge network platform, a set of radio layer 2 (L2) functionalities implementing communication services; allocating, to the edge network platform, first user plane functionalities implementing computation services; allocating, to a cloud network platform, core network functionalities implementing mobility and authorization and second user plane functionalities implementing the computation services, where the computation services are distributed at least in the cloud network platform and the edge network platform; and allocating, to a site network platform, a set of radio layer 1 (L1) functionalities implementing link adaptation, retransmission, and segmentation for users.

One or more aspects of the subject disclosure are directed to a non-transitory machine-readable medium, including executable instructions that, when executed by a processing system including a processor, facilitate performance of operations. The operations include configuring a cloud network platform to implement control plane functionalities and first user plane functionalities; configuring an edge network platform to implement a radio layer 2 (L2) functionalities and second user plane functionalities; and configuring a site network platform to implement a radio layer 1 (L1) functionalities; where the L2 functionalities comprises configuration and resource allocation for users, and the second user plane functionalities comprises duplication, encryption, a quality of service (QOS) for a local breakout, sidelink communication, or a combination thereof.

One or more aspects of the subject disclosure are directed to a method including implementing, by a processing system including a processor, a cloud network platform configured to run control plane functionalities and first user plane functionalities; implementing, by the processing system, an edge network platform capable to run both communication functionalities and second user plane functionalities; and implementing, by the processing system, a site network platform configured to run a radio layer 1 (L1) functionalities, where the site network platform is not equipped with processing of user plane functionalities and wherein the cloud network platform is not equipped with processing of the communication functionalities.

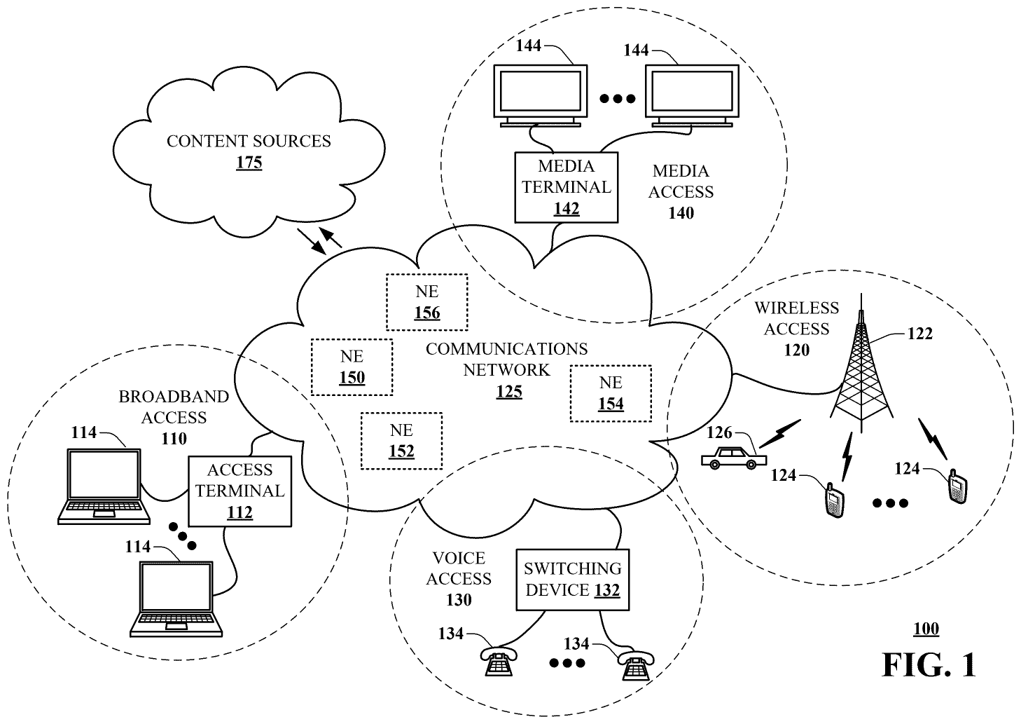

Referring now to FIG. 1, a block diagram is shown illustrating an example, non-limiting embodiment of a system 100 in accordance with various aspects described herein. For example, system 100 can facilitate in whole or in part systems and methods facilitating distributed communications and computing services and applications over wireless communication networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VOIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

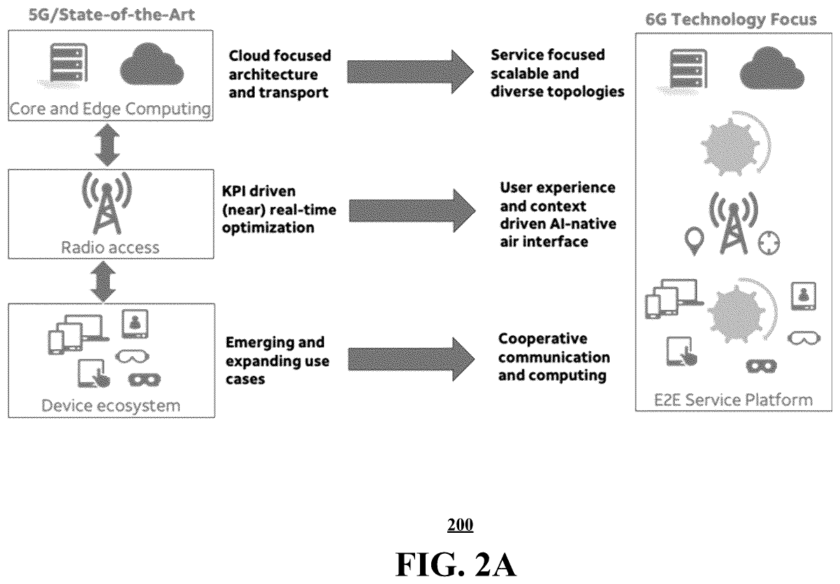

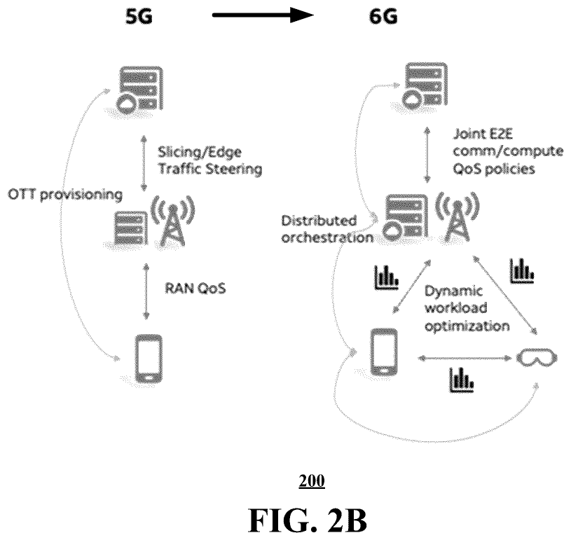

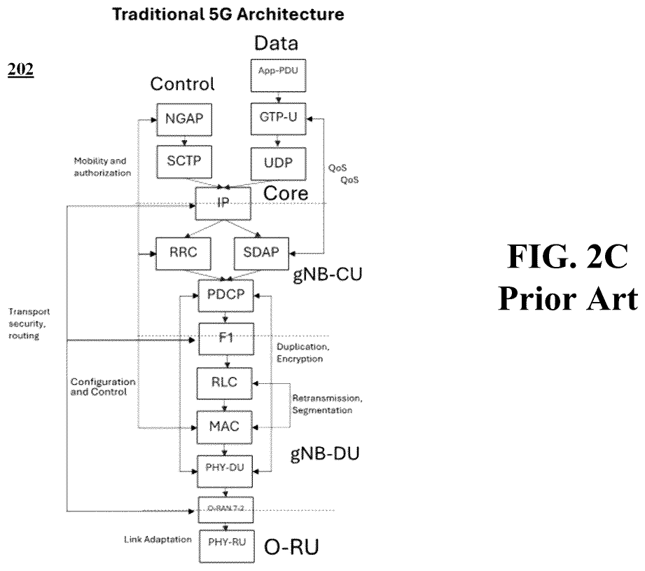

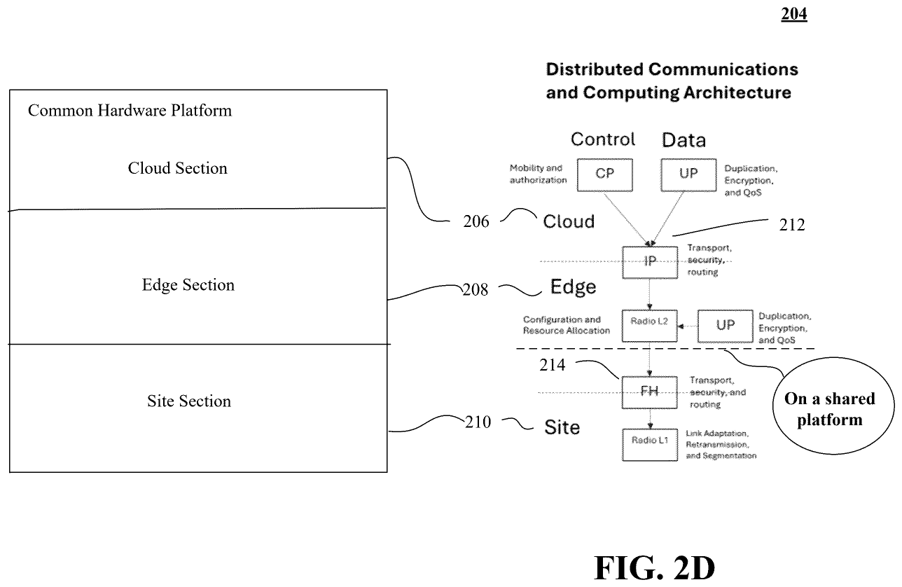

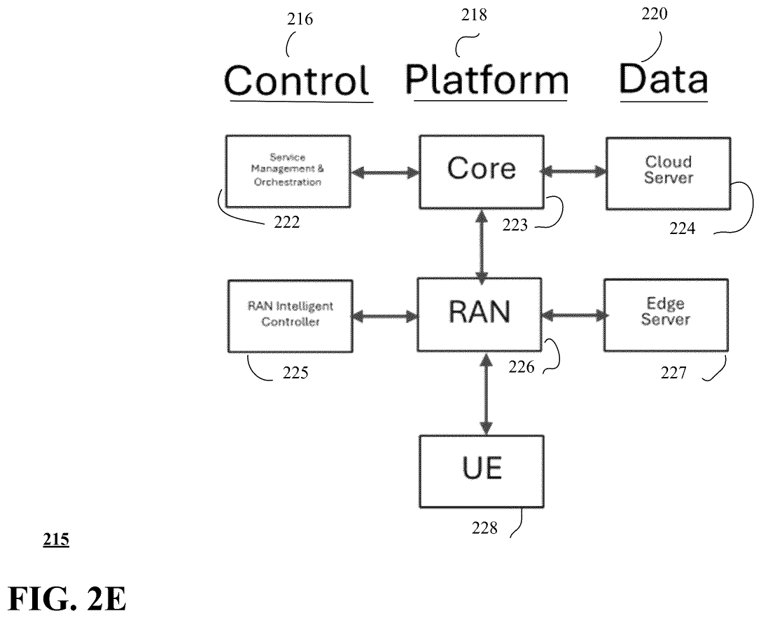

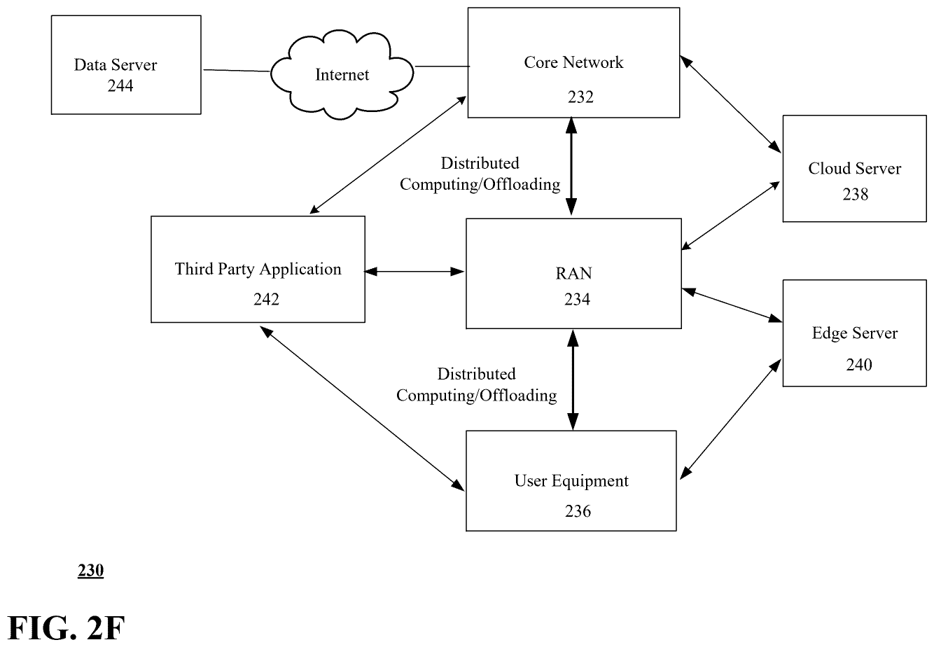

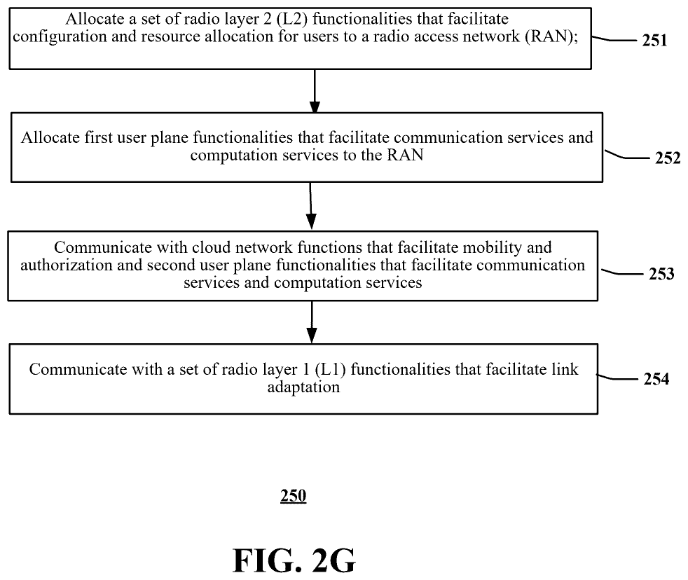

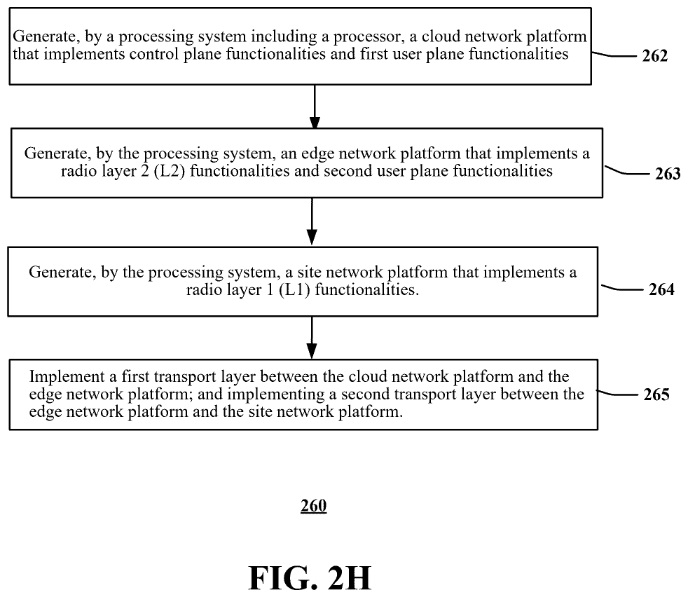

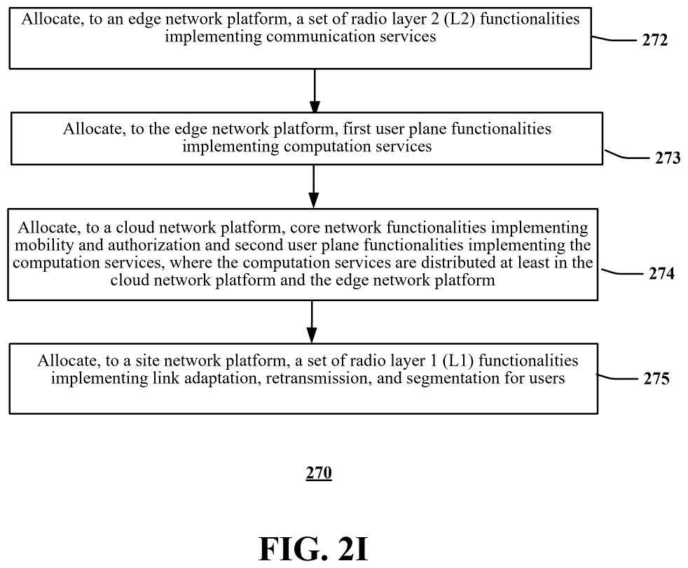

FIG. 2A depicts illustrative differences between a 5G/state of the art communication architecture and a 6G technology focus. Extended Reality (XR) Advanced Media and Digital Twin are newly proposed Metaverse services which recreate physical world characteristics in a digital environment (e.g., hyper-realistic 3D maps) and optimize quality of experience of digital services in a physical world environment (e.g., real-time holographic avatar interactions). The XR Advanced Media and Digital Twin build upon extended reality (XR) applications including augmented reality (AR), virtual reality (VR), and cloud gaming (CG).

Examples of Metaverse and Digital Twin use cases include industrial automation, factory management and maintenance, remote training, multimedia streaming, XR conversational services, XR cloud gaming, AR guided assistance at remote locations, AR animated avatar calls, shared spatial data, digitally augmented shopping and retail experiences, immersive stadium experiences, AR animated avatar calls, etc.

As shown in FIG. 2A, to deploy the above-described advanced services, the architecture of the 5G or 6G radio access network may need to become a unified platform which can facilitate and support both communication and computation service requirements. This may include a range of features such as cloud focused architecture and transport to enable service focused scalable and diverse topologies or KPI driven (near) real-time optimization leading to a user experience and context driven AI-native air interface. Additionally, many of these emerging and expanding use cases such as joint-communication and sensing (JCS), split-rendered XR, and AI-generative media have throughput, latency, and computational processing requirements that can be met by cooperative communication and computing at the local network edge and/or distributed across multiple devices (e.g., wearable displays, smartphones, and edge servers).

Split Compute/Rendering is one exemplary advanced XR application where both computing and computation network functions are required to support processing and pre-rendering of immersive scenes and the delivery is split into more than one connection. As a result, the latency and interactivity requirements can be very challenging to be met by existing local-only or cloud computing outside of the radio access network. For example, a XR user device may have sensors which are used for environmental perception and a XR application is able to generate a XR media based on local positioning and video data and combine that with any received media and metadata from a network or an edge server over a communication link before sending the media to a XR display (which may be wirelessly tethered to the XR user device).

Much of the focus of distributed computing has stopped at the RAN and Core network interface. A new air interface and network architecture may be needed to distribute computing all the way to the devices such that device side resources (computing, data, services) can be integrated into the open RAN compute fabric. Besides the technical requirements for meeting the communication and computation QoS requirements, privacy and security also may need to be supported in a hierarchical network architecture including local network breakout and network-in-network topologies with multiple Radio Access Technologies (RAT), ownership, transparency, fair use issues associated with offloading computation to devices (or vice-versa).

FIG. 2B depicts illustrative 5G and 6G environments. One of aspects of 5G environments includes the introduction of cloud Radio Access Network (RAN) as well as a cloud core network. Specialized hardware has been moved to more common computation platforms where functions in services are running in software and at the same time, applications are also running on common computation platforms. Cloud gaming, cloud storage, cloud gaming, etc. have become accessible and available. Many of these cloud based services are important for applications that require a large amount of computation. For instance, virtual reality or augmented reality may use significant amount of either machine learning or visual 3D processing request which cannot be solely done on a device due to limited computation as well as energy consumption.

A significant merging of these technologies may take place in the next generation communication network such as 6G. In that case, hardware that is being used for a base station to provide services, i.e., communication services may be similar to servers and platforms required for running the computation of actual applications. For instance, a GPU may be used for machine learning on the base station for its algorithms to improve the communication link. The GPU can also be used for computing some of the 3D graphics required for a low latency AR application. In this case, beyond edge computing, distributed computing comes into play. Not only the device involved but also edge servers, which may be offered by a third party vendor, can be integrated into a core network and then devices will have some workload that is managed by the devices. Additionally, a radio access network including base stations can also be a part of the distributed computing.

As depicted in FIG. 2B, computing is distributed such that historically device side resources (compute, data, services) can be integrated into the 6G network compute fabric and leverage cloud/IT technologies within the RAN to dynamically provision and share resources between network and service workloads. Offloading computation also involves privacy, security, and ownership issues that may require greater visibility and transparency in the RAN. In addition, network improvements are required to optimally connect and orchestrate distributed cloud resources.

The distributed computing may need to be implemented dynamically and efficiently, such as avoiding building massive amounts of computation servers at base station sites. On the other hand, building computation servers at edge sites may not meet latency requirements. It is desirable to provide dynamic ability to move resources required for the computation from an edge of the network to a base station to a device and at the same time, ensure that a communication link can support such dynamic ability such that the throughput and latency requirements can be met for the computation service. In light of these factors and considerations, the distributed computing is natively brought into the RAN at least because the RAN has become a cloud computing service. In the 5G networks, cloud computing support the edge or the core, and in 6G networks, as depicted in FIG. 2B, the cloud computing may be distributed among core, the base station and devices.

In various embodiments, the RAN (such as base stations) play an important role as well as devices. Devices and the network may blur, in the 6G networks, as depicted in FIG. 2B, in terms of an air interface, as opposed to a hierarchical structure in the 5G networks where all decisions are coming from a central location and distributed down (see FIG. 2C). The 6G networks are directed to more distributed intelligence and distributed work. To some extent, devices and the RAN will become more peers rather than hierarchical relationships like in the 5G networks. In the current cloud computing, devices may need to find a cloud computing service that can provide the computation or storage or both, and devices use a communication link to transfer data and manage requirements of the service. To some extent, the RAN transfers the data and is transparent to that service. In the 5G networks, a quality of service (QOS) is a communication metric and the RAN is primarily responsible to ensure a certain throughput or latency. The RAN does not differentiate whether any of data from the device is related to a local computation. Offloading, for example, splits compute rendering where the device is partially rendering a scene and then offloading some of tasks to the cloud computing entity that is then solely at an application layer. Then there may be no possibility to manage quality of computation service itself, whether or not there are sufficient computation resources, whether those resources can be met in a certain computation budget, latency, timeline, etc. These considerations are separate from the communication link quality of service metrics.

In various embodiments, if the base station itself now is implemented in a similar platform as a third party over the top cloud computing service, the base station can offer the computation service to the device. Instead of the device having to send through the base station to the core network, the device can directly offload it to the base station as a RAN computation platform. Current air interfaces may not support this type of split of a transportation pipeline. A significant change to the current air interface may be needed to support this type of local offload.

FIG. 2C depicts exemplary protocol stack layers 202 in a traditional 5G environment. As shown in FIG. 2C, in the traditional 5G architecture, the RAN and core entities are defined based on distinct protocol stack layers with heterogenous interfaces and transport technologies (e.g., IP, GTP, O-RAN 7-2x) and this may result in redundant functionality and very complex control and user plane protocols between the device, RAN nodes (e.g., O-RU, O-DU, and O-CU), and core network functions (e.g., User Plane Function (UPF), Network Exposure Function (NEF), etc.).

FIG. 2D is a block diagram illustrating an example, non-limiting embodiment of a system architecture 204 functioning within the communication network of FIG. 1 in accordance with various aspects described herein. In various embodiments, as depicted in FIG. 2D, new RAN-Core Network (CN) architecture and interfaces are defined to support deployment options where traditionally RAN and CN entities are co-located on virtualized and open platforms (e.g., Commercial Off The Shelf (COTS) servers).

In various embodiments, the RAN and core network entities are implemented as virtualized open software functions with RESTful interfaces, which support implementation on a cloud platform with open and interoperable interfaces (e.g., supporting O-RAN service models and interfaces). The term, REST refers to representative state transfer, as is well appreciated in the pertinent art. A RESTful API is an architectural style for an application program interface (API) that uses HTTP requests to access and use data. That data can be used to GET, PUT, POST and DELETE data types, which refers to the reading, updating, creating and deleting of operations concerning resources.

In various embodiments, the distributed computing and communications architecture and air interfaces are simplified compared to the traditional RAN and core network protocol stack and network functionalities 202, as depicted in FIG. 2C. The location of different virtualized network functionalities are defined by their location relative to the user devices and applications as shown in FIG. 2D and are organized into three categories: Cloud network platform 206, Edge network platform 208, and Site network platform 210.

In various embodiments, cloud network functions of the Cloud network platform 206 include control plane (CP) functionalities which support mobility and authorization for users and user plane (UP) functionalities which support duplication, encryption, QoS for communication and computation services. In the 5G network, the core network may operate in a cloud with cloud architecture, and in the 6G and/or next generation networks, less hierarchical architecture than the 5G hierarchical siloed core network may be used in the Cloud network platform 206. Some IP packets are passed to some servers that are implemented on the Cloud network platform 206, which may not handle low latency or local services from the Cloud network platform 206. The Cloud network platform 206 does not handle the communication service.

In various embodiments, edge network functions of the Edge network platform 208 includes radio layer 2 (L2) functionalities which support configuration and resource allocation for users (e.g., scheduling, initial access, and radio resource management) and user plane (UP) functionalities which support duplication, encryption, QoS for local breakout and/or sidelink communication and computation services. The L2 functionalities may include functions of an RAN intelligent controller (RIC). For instance, the L2 functionalities may include the RIC functions and protocol stack functions (e.g., packet processing functions). The Edge network platform 208 manages such that the communication configuration and resource allocation like the communication QoS are co-located with the computation functions that are handling like the traditional user plane functions such as duplication, encryption and the QoS for the computation service. In other words, the Edge network platform 208 implements logically separate functions on the same platform. The Edge network platform 208 thus allows a flexibility to move the user plane primarily focusing on the computation aspect, although the Edge network platform 208 can be used for routing of traffic. Resources required for the L2 functionalities and resources required for the local user plane can be dynamically shared.

In various embodiments, the Cloud network platform 206 may handle non-real time services like video streaming, social media. The Edge network platform 208 may handle local services and local data offload in order to allow scaling of the local traffic by leveraging resources that may be at the RAN and on user devices. For instance, for an XR type application, the Cloud network platform 206 handles media streaming source and the Edge network platform 208 handles local computation. Depending on applications, the user plane data is handled in the Edge network platform 208, instead of the Cloud network platform 206 or vice versa.

In various embodiments, site network functions of the Site network platform 210 include radio layer 1 (L1) functionalities which support link adaptation, retransmission, and segmentation for users (e.g., CSI (Channel State Information) estimation, beamforming, Hybrid Automatic Repeat Request (HARQ), etc.). The Site network platform 210 does not handle computation.

In various embodiments, transport layers between the Cloud and Edge network platforms may be based on an IP layer 212 which facilitates and implements transport, security and routing functionality. This allows UDP to connect both the Cloud network platform 206 and the Edge network platform 208. In addition, transport layers 214 between the Edge and Site network platforms may be based on a dedicated fronthaul (FH) protocol which is optimized for open RAN interfaces.

In the traditional 5G architecture, a provisioning of a computation service is handled by edge servers and the RAN is primarily responsible for the quality of service of a communication link. All of traffic steering is related to selecting services that are not involving the RAN computation capabilities. On the other hand, the distributed communications and computing architecture 204 depicted in FIG. 2D enable the selection of the computation service, for example, in the RAN such as a base station or at the edge or across user devices. By way of example only, GPUs at the base station may be used for the computation service. It is also meaningful to make known, computation workload available at the RAN, as user devices and edge servers may not know if there is a local resource where low latency or local traffic can be offloaded across devices. User devices can share workload between them or the base station and the core network. The architecture 204 may unify the computation workload and may be no longer hierarchical from a device endpoint or edge point. As these devices need to share information with each other in order to determine the appropriate workload optimization over a communication link, the communication link QoS and the computation QoS should be jointly decided in order to make the optimal decision. In addition, a new air interface design may be needed to treat the RAN and the current air interface as a part of the computation workload distribution network.

In various embodiments, a common hardware platform can be used to implement control, data, radio and UDP functions. Common Commercial Off The Shelf (COTS) hardware implementation can have three sections, each of which implements the Cloud, the Edge and the Site network platforms 206, 208 and 210, respectively, as depicted in FIG. 2D. Each section needs to have different functional capabilities for which each section is optimized. The section implementing the Cloud network platform 206 may have data center type implementations and the section implementing the Site network platform 210 may have more real time processing oriented implementations. The section implementing the Edge network platform 208 is a hybrid implementation where it has some aspects that are involved in data storage and some real time processing with low latency compared to processing at the Cloud network platform section. The Site network platform section does not have capability of doing the data storage. The common hardware platform depicted in FIG. 2D is by way of example only and the present disclosure is not limited thereto.

FIG. 2E is a block diagram illustrating an example, non-limiting embodiment of another system 215 functioning within the communication network of FIG. 1 in accordance with various aspects described herein. FIG. 2E provides an example architecture 215 for implementation of the previously described distributed communications and computing network and protocol stacks. The architecture can be divided into three domains, a control plane 216, a data plane 220, and a hardware/software platform 218. In some embodiments, the hardware/software platform may be virtualized with centralized or distributed components as explained earlier. The hardware/software platform 218 includes the core system 223, the RAN 226, and the user equipment (UE) 228 including and representing various types of user devices. For instance, the Cloud network platform 206 encompasses control and data functions 222, 224 on a core network platform 223, the Edge network platform 208 encompasses control and data functions 225, 227 on a radio access network (RAN) 226. The RAN 226 as depicted in FIG. 2E may encompass the Site network platform 210 which connects with user equipment (UE) 228.

In various embodiments, control functions by the core system 223, such as core network functions 222, provide service management and orchestration to enable a distributed communications and computing service including provisioning quality of service, subscription and service level agreement aspects, user authorization and E2E security, and APIs for network slicing or 3rd party applications associated with the user/service. Additionally, the core system 223 may identify availability of resources and provide routing between the user equipment 228 and a network or a third party cloud server located outside of the network.

In various embodiments, a RAN intelligent controller 225 controls operations and functions of the RAN 226. The RAN intelligent controller 225 may enable dynamic connectivity between the user equipment 228 and one or more edge servers 227 within the RAN over the air interface as well as the associated radio resources used for transport of data to/from the UE 228 and the network. The RAN intelligent controller 225 may additionally provide RAN-level key performance indicators (KPIs) associated with services to the UE 228 or third party applications. This may enable the UE 228 to instead make a determination of whether to dynamically adapt between edge and cloud computing resources based on the availability of compute resources in the RAN. The edge and cloud computing resources can be provided by a cloud server 224 and the edge server 227. In FIG. 2D, the RAN intelligent controller 225 is described as one example, but the present disclosure is not limited thereto. Various other processors or controllers can be used.

FIG. 2F is a block diagram illustrating an example, non-limiting embodiment of another system 230 functioning within the communication network of FIG. 1 in accordance with various aspects described herein. The system 230 includes a core network 232, a RAN 234 and user equipment 236 including various types of different user devices. The system 230 also includes a cloud server 238 and an edge server 240 operating in connection with the core network 232, the RAN and the user equipment 236. Various third party applications 242 are also available. In various embodiments, the user equipment 236 operates to request data or information via the RAN 234 and the core network 232 to a data server 244 through Internet. In the system 230, computing is distributed such that device side sources such as the user equipment 236, the edge server 240, the third party application 242, etc. can be integrated into the RAN 234 compute fabric. The cloud server 238 and the edge server 240 can be leveraged within the RAN 234 to dynamically provide and share resources between the network and service workloads. In some embodiments, the RAN 234 serves as a more integrated role to orchestrate distribution and offloading between network elements such as the core network 232, the user equipment 236, the cloud server 238 and the edge server 240.

In various embodiments, the RAN 234 may be implemented with more powerful computing hardware and software applications to facilitate and support computing distribution and offloading workloads. The RAN 234 can also operate to communicate with the core network 232 and the user equipment 236 to perform dynamic offloading vertically and/or horizontally and encompass third party applications and cloud computing resources at the cloud server 238 and the edge server 240.

In various embodiments, some resources can be provided locally for a limited time to handle edge computing by the edge server 240 via the third party application 242. Such resources are locally hosted on a platform of the RAN 234 and both communication and computation services can be provided by one service provider. A communication provider can support distributed computing resources. For instance, a temporary agreement can be offered to enable offloading of some computation load for a short period of time in a base station and when a user leaves a site and is no longer connected to the base station, resources offered to enable offloading may be released and can either be used for communication or computation for a different user. Resources available at the base station in many contexts can be dynamically used on a demand basis. For instance, a data server actually present at the base station (running in a cloud mode) can run the RAN software and application software and decide how to split resources based on information provided by the network about quality of experience. A service agreement may include availability of computation resources in the RAN platform. Additionally, user devices can be involved in deciding where to do offloading of the computation load. An application may request computation resources and those resources can be assigned on a user device, on a base station or on a data server.

FIG. 2G depicts an illustrative embodiment of a method 250 in accordance with various aspects described herein. In various embodiments, the method 250 includes allocating a set of radio layer 2 (L2) functionalities that facilitate configuration and resource allocation for users to a radio access network (RAN) (Step 251), allocating first user plane functionalities that facilitate communication services and computation services to the RAN (Step 252), communicating with cloud network functions that facilitate mobility and authorization and second user plane functionalities that facilitate communication services and computation services (Step 253), and communicating with a set of radio layer 1 (L1) functionalities that facilitate link adaptation (Step 254).

In various embodiments, the communicating with the cloud network functions (Step 253) further include communicating, via a RESTful (Representational State Transferful) interface, with the cloud network functions. The communicating with the cloud network functions (Step 253) further include communicating with the cloud network functions using an IP layer as a transport layer. The communicating with the set of L1 functionalities (Step 254) include communicating via a fronthaul connection. The allocating user plane functionalities (Step 252) further includes offloading computation resources in the RAN.

In various embodiments, the method 250 further includes performing a distributed orchestration of computation resources at the RAN, using the first user plane functionalities and the second user plane functionalities. The method 250 further includes dynamically preparing and sharing computation resources within a wireless communication network including the RAN.

In various embodiments, the method 250 further includes maintaining both the communication services and the computation services on a shared computation platform configured by the edge network platform, wherein the edge network platform includes a software-defined radio access network (RAN). The method 250 further includes dynamically adjusting allocation of resources for the distributed computation services to the cloud network platform, the edge network platform, or both. The set of L2 functionalities in the edge network platform further includes configuration and resource allocation for the communication services, the core network functionalities in the cloud network platform include no communication services, and the L1 functionalities in the site network platform includes no computation services. The method 250 further includes implementing the cloud network platform in a first section of a common hardware platform, implementing the edge network platform in a second section of the common hardware platform, and implementing the site network platform in a third section of the common hardware platform. The first section of the common hardware platform is configured as a wireless data center, the second section of the common hardware platform is configured to provide computing resources for supporting low latency applications, and the third section of the common hardware platform is configured to provide computing resources for supporting real time processing.

In various embodiments, the method 250 further includes performing a distributed orchestration of computation resources in the cloud network platform and the edge network platform, using the first user plane functionalities and the second user plane functionalities.

FIG. 2H depicts an illustrative embodiment of another method 260 in accordance with various aspects described herein. In various embodiments, the method 260 includes generating a cloud network platform that implements control plane functionalities and first user plane functionalities (Step 262); generating an edge network platform that implements a radio layer 2 (L2) functionalities and second user plane functionalities (Step 263); generating a site network platform that implements a radio layer 1 (L1) functionalities (Step 264); and implementing a first transport layer between the cloud network platform and the edge network platform and implementing a second transport layer between the edge network platform and the site network platform (Step 265).

In various embodiments, the implementing the control plane functionalities further includes facilitating mobility and authorization for users and the implementing the first user plane functionalities further comprises facilitating duplication, encryption and a quality of service (QOS) for communication and computation services. The implementing the radio L2 functionalities further includes facilitating configuration and resource allocation for users. The configuration and resource allocation for users further comprise scheduling, initial access, and radio resource management. The implementing the second user plane functionalities further comprises facilitating duplication, encryption and a quality of service (QOS) for a local breakout, sidelink communication and computation services or both. The implementing the radio L1 functionalities further comprises facilitating link adaptation, retransmission, and segmentation for users. The implementing the first transport layer further includes generating an IP layer; and the implementing the second transport layer further comprises using a dedicated fronthaul protocol optimized for open RAN interfaces.

In various embodiments, another method includes generating by a processing system including a processor, a cloud network platform that implements control plane functionalities and first user plane functionalities; generating, by the processing system, an edge network platform that implements a radio layer 2 (L2) functionalities and second user plane functionalities; and generating, by the processing system, a site network platform that implements a radio layer 1 (L1) functionalities.

In various embodiments, the implementing the control plane functionalities further comprises facilitating mobility and authorization for users and the implementing the first user plane functionalities further comprises facilitating duplication, encryption and a quality of service (QOS) for communication and computation services. The method further includes dynamically preparing and sharing, by the processing system, computation resources in the edge platform. The method further includes utilizing, by the processing system, a RESTful interface between the cloud platform and the edge platform. The method further includes utilizing, by the processing system, a dedicated fronthaul protocol which is optimized for open RAN interfaces between the site platform and the edge platform. The implementing the first user plane functionalities further comprises facilitating duplication, encryption and a quality of service (QOS) for communication and computation services. The implementing the second user plane functionalities further comprises facilitating duplication, encryption and a quality of service (QOS) for a local breakout, sidelink communication and computation services or both.

In various embodiments, a method include implementing a control plane domain that implements core network functions and implements radio access network (RAN) functions; implementing a data plane domain including a cloud server and an edge server; and generating a platform domain implemented with a mobile core, a RAN network and a user equipment.

In various embodiments, the core network functions provide service management and orchestration to enable a distributed communication and computing service. The enabling the distributed communication and computing service comprises provisioning quality of service, subscription and service level agreement aspects, user authorization and E2E security, and APIs for network slicing or third party applications associated with the user equipment and services. The core network functions further identify availability of resource and provide routing between the user equipment and the cloud server located outside of a network.

In various embodiments, the implementing the control plane domain that implements the RAN functions further comprise: with a RAN intelligent controller, enabling dynamic connectivity between the user equipment and the edge server within the RAN over an air interface and with the RAN intelligent controller, enabling associated radio resources used for transport of data. The implementing the control plane domain that implements the RAN functions further comprise: with the RAN intelligent controller, providing RAN-level key performance indicators (KPIs) associated with services to the user equipment or a third party application. Based on the RAN-level KPIs associated with the services, the user equipment or the third party application is enabled to make a determination of whether to dynamically adapt between edge and cloud computing resources based on availability of compute resources in the RAN.

FIG. 2I depicts an illustrative embodiment of another method 270 in accordance with various aspects described herein. In various embodiments, the method 270 includes allocating, to an edge network platform, a set of radio layer 2 (L2) functionalities implementing communication services (Step 272); allocating, to the edge network platform, first user plane functionalities implementing computation services (Step 273); allocating, to a cloud network platform, core network functionalities implementing mobility and authorization and second user plane functionalities implementing the computation services, where the computation services are distributed at least in the cloud network platform and the edge network platform (Step 274); and allocating, to a site network platform, a set of radio layer 1 (L1) functionalities implementing link adaptation, retransmission, and segmentation for users (Step 275).

In various embodiments, the method 270 further includes implementing the edge network platform in a software-defined radio access network. The method 270 further includes allocating resources to perform the L2 functionalities for communication and to perform the second user plane functionalities for computation. The method 270 includes dynamically adjusting the allocation of resources between communication and computation based on a computation load offloading request from user equipment. The method 270 further includes, at the edge network platform, processing a request to offload a computation load for a predetermined period of time by a first user equipment (UE), and at the edge network platform, releasing resources used for the offloading of the computation load after elapse of the predetermined period of time. The method 270 includes, at the edge network platform, releasing the resources used for the offloading of the computation load when the first UE is disconnected from the edge network platform.

In various embodiments, the method 270 includes maintaining the edge network platform as a shared platform for the communication functionalities and the second user plane functionalities. The method 270 further includes dynamically adjusting, by the processing system, allocation of resources between the communication functionalities and the second user plane functionalities in the edge network platform. The method 270 includes arranging a data server at the edge network platform, where the data server is configured to process the communication functionalities and the second user plane functionalities.

While for purposes of simplicity of explanation, the respective processes are shown and described as a series of blocks in FIGS. 2G through 2I, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

In the above embodiments, systems and methods for enabling distributed communications and computing services and applications over wireless communication networks such as 5G O-RAN or 6G networks are described. The air interface protocol stack design and open RAN architecture to optimize quality of experience (QoE) for communication and computation services. Quality of experience (QoE) is from user's viewpoint and its own concept of a good quality. The quality of service (QOS) mainly influences the UE's QoE. For instance, QoS parameters include bandwidth, jitter, delay and packet loss, and the delay and packet loss rate may be two main QoS parameters that can be improved to improve the user-perceived QoE.

In the above described embodiments, support for distributed data computing within a 6G network across devices and network nodes will enable more flexible deployment scenarios, architectures that reduce local latency, and better inter-node coordination. New service revenue opportunities for service providers through dynamically offloading computation workloads from devices to network nodes can be generated. Users are allowed to experience these types of services anywhere and anytime on the 5G or 6G mobile network, which were previously limited (or not supported) on mobile networks and can instead be experienced across an increasing mix of device form factors including wearables, XR displays, smartphones, and standalone devices.

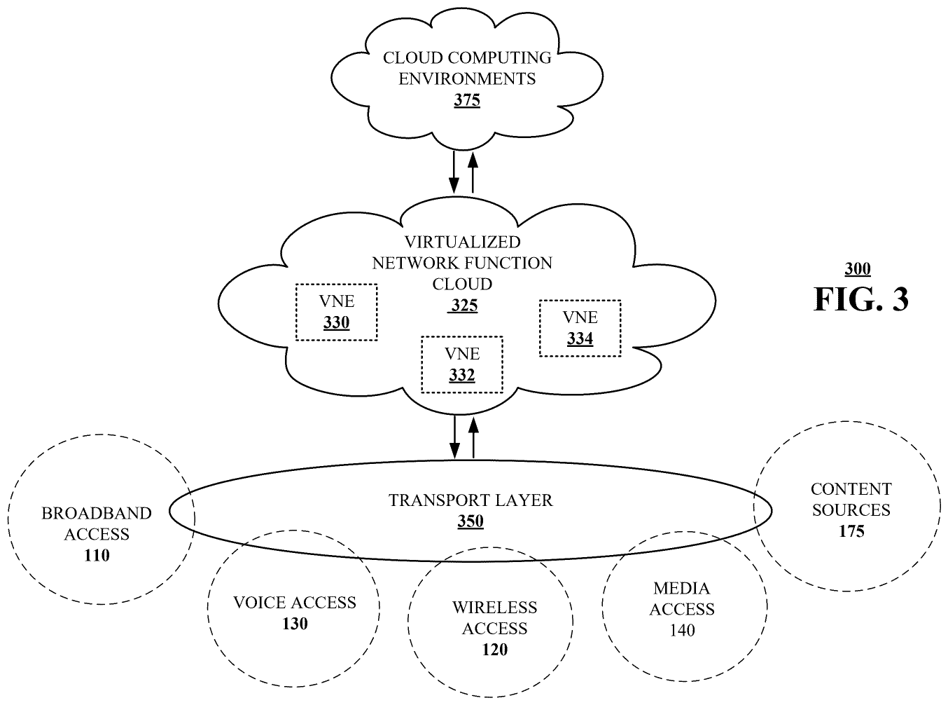

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 204, 215, 230 and method 250, 260, 270 presented in FIGS. 1, 2D, 2E, 2F˜2I, and 3. For example, virtualized communication network 300 can facilitate in whole or in part systems and methods facilitating distributed communications and computing services and applications over wireless communication networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

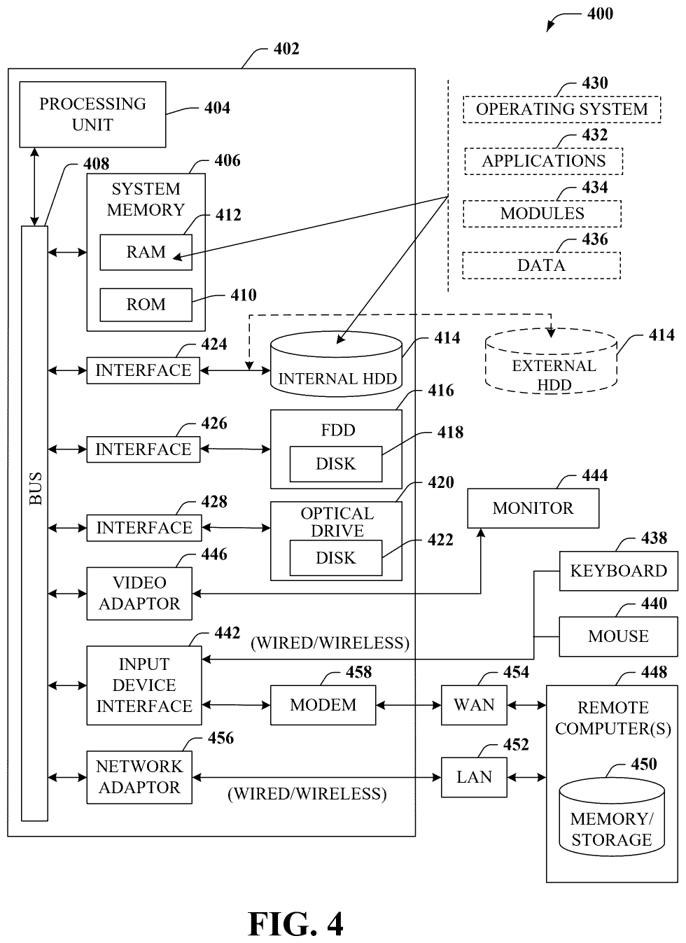

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part systems and methods facilitating distributed communications and computing services and applications over wireless communication networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

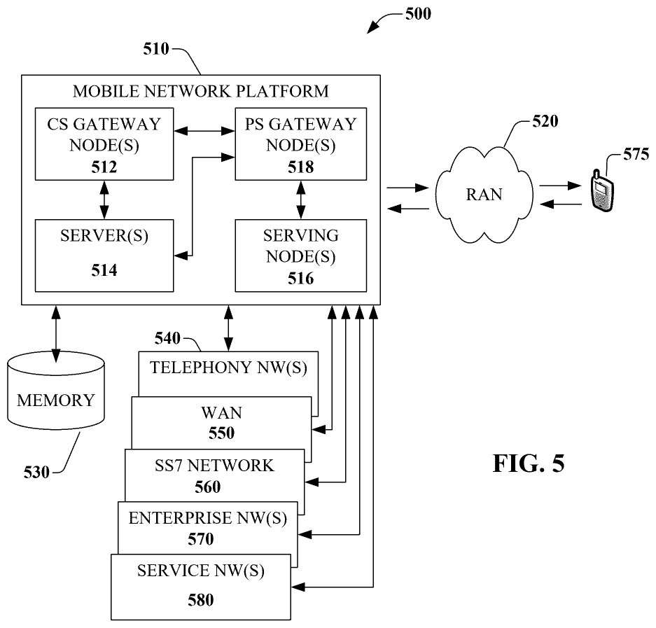

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part systems and methods facilitating distributed communications and computing services and applications over wireless communication networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology (ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

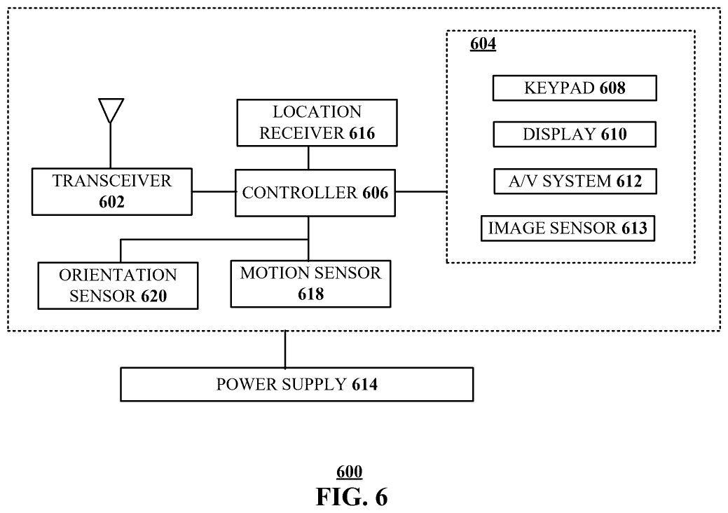

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part systems and methods facilitating distributed communications and computing services and applications over wireless communication networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A system, comprising:
a processing system including a processor; and
a memory that stores executable instructions that, when executed by the processing system, facilitate performance of operations, the operations comprising:
allocating, to an edge network platform, a set of radio layer 2 (L2) functionalities implementing communication services;
allocating, to the edge network platform, first user plane functionalities implementing computation services;
allocating, to a cloud network platform, core network functionalities implementing mobility and authorization and second user plane functionalities implementing the computation services, wherein the computation services are distributed at least in the cloud network platform and the edge network platform; and
allocating, to a site network platform, a set of radio layer 1 (L1) functionalities implementing link adaptation, retransmission, and segmentation for users.

2. The system of claim 1, wherein the operations further comprise maintaining both the communication services and the computation services on a shared computation platform configured by the edge network platform, wherein the edge network platform is implemented as a software-defined radio access network (RAN).

3. The system of claim 1, wherein the operations further comprise dynamically adjusting allocation of resources for the distributed computation services to the cloud network platform, the edge network platform, or both.

4. The system of claim 1, wherein:
the set of L2 functionalities in the edge network platform further comprises configuration and resource allocation for the communication services;
the core network functionalities in the cloud network platform include no communication services; and
the set of L1 functionalities in the site network platform includes no computation services.

5. The system of claim 1, wherein the operations further comprise:
implementing the cloud network platform in a first section of a common hardware platform;
implementing the edge network platform in a second section of the common hardware platform; and
implementing the site network platform in a third section of the common hardware platform.

6. The system of claim 5, wherein the first section of the common hardware platform is configured as a wireless data center, the second section of the common hardware platform is configured to provide computing resources for supporting low latency applications, and the third section of the common hardware platform is configured to provide computing resources for supporting real time processing.

7. The system of claim 1, wherein the operations further comprise:
performing a distributed orchestration of computation resources in the cloud network platform and the edge network platform, using the first user plane functionalities and the second user plane functionalities.

8. The system of claim 1, wherein the operations further comprise:
facilitating communication between the edge network platform and the cloud network platform using an IP layer as a transport layer and via a RESTful (Representational State Transferful) interface; and
facilitating communication between the edge network platform and the site network platform via a fronthaul connection.

9. A non-transitory machine-readable medium, comprising executable instructions that, when executed by a processing system including a processor, facilitate performance of operations, the operations comprising:
configuring a cloud network platform to implement control plane functionalities and first user plane functionalities;
configuring an edge network platform to implement a radio layer 2 (L2) functionalities and second user plane functionalities; and
configuring a site network platform to implement a radio layer 1 (L1) functionalities;
wherein the L2 functionalities comprises configuration and resource allocation for users, and the second user plane functionalities comprises duplication, encryption, a quality of service (QOS) for a local breakout, sidelink communication, or a combination thereof.

10. The non-transitory machine-readable medium of claim 9, wherein the operations further comprise implementing the edge network platform in a software-defined radio access network.

11. The non-transitory machine-readable medium of claim 10, wherein the operations further comprise allocating resources to perform the L2 functionalities for communication and to perform the second user plane functionalities for computation.

12. The non-transitory machine-readable medium of claim 11, wherein the operations further comprise, in the edge network platform, dynamically adjusting the allocation of resources between communication and computation based on a computation offloading request from user equipment.

13. The non-transitory machine-readable medium of claim 9, wherein the operations further comprise:
at the edge network platform, processing a request to offload a computation load for a predetermined period of time by a first user equipment (UE); and
at the edge network platform, releasing resources used for the offloading of the computation load after elapse of the predetermined period of time.

14. The non-transitory machine-readable medium of claim 13, wherein the operations further comprise, at the edge network platform, releasing the resources used for the offloading of the computation load when the first UE is disconnected from the edge network platform.

15. A method, comprising:
implementing, by a processing system including a processor, a cloud network platform configured to run control plane functionalities and first user plane functionalities;
implementing, by the processing system, an edge network platform capable to run both communication functionalities and second user plane functionalities; and
implementing, by the processing system, a site network platform configured to run a radio layer 1 (L1) functionalities, wherein the site network platform is not equipped with processing of user plane functionalities and wherein the cloud network platform is not equipped with processing of the communication functionalities.

16. The method of claim 15, wherein the implementing the edge network platform further comprises maintaining the edge network platform as a shared platform for the communication functionalities and the second user plane functionalities.

17. The method of claim 16, further comprising:
dynamically adjusting, by the processing system, allocation of resources between the communication functionalities and the second user plane functionalities in the edge network platform.

18. The method of claim 15, wherein the implementing the edge network platform further comprises arranging a data server at the edge network platform, wherein the data server is configured to process the communication functionalities and the second user plane functionalities.

19. The method of claim 15, wherein the implementing the edge network platform further comprises configuring the edge network platform in a software-defined radio access network.

20. The method of claim 15, further comprising:
implementing, by the processing system, the cloud network platform in a first section of a common hardware platform;
implementing, by the processing system, the edge network platform in a second section of the common hardware platform; and
implementing, by the processing system, the site network platform in a third section of the common hardware platform,
wherein the first section is adapted to perform non-real time processing, the second section is adapted to perform low latency processing, and the third section is adapted to perform real time processing.
